(19) United States
(12) Patent Application Publication
(10) Pub. No.: US 2016/0054900 A1
(43) Pub. Date: Feb. 25, 2016

(54) Computer Implemented System and Method for Producing 360 Degree Perspective Images

(71) Applicants: Chuck Surack, Fort Wayne, IN (US); John Hopkins, Fort Wayne, IN (US); Michael Ross, Fort Wayne, IN (US); Mike Clem, Grabill, IN (US); Greg Wardwell, Columbia City, IN (US); Dan Schafer, Fort Wayne, IN (US)

(72) Inventors: Chuck Surack, Fort Wayne, IN (US); John Hopkins, Fort Wayne, IN (US); Michael Ross, Fort Wayne, IN (US); Mike Clem, Grabill, IN (US); Greg Wardwell, Columbia City, IN (US); Dan Schafer, Fort Wayne, IN (US)

(21) Appl. No.: 14/467,898

(22) Filed: Aug. 25, 2014

(51) Int. Cl. G06F 3/0484

(52) U.S. Cl. CPC G06F 3/04845; G06F 3/04847; G06F 3/04842

(57) ABSTRACT

An Internet based computer-implemented method for generating and displaying an image of an object on a users computer screen, wherein said image may be rotated 360° about a horizontal axis and 360° about a vertical axis, the method comprising the steps of: accessing a database of digital images or a product; evaluating said user's computer hardware parameters, where said parameters are selected from the group consisting of Internet connection speed, Internet connection type, type of computing device, and type of Internet browser software; determining the dimensions of the display field of the computing device; determining a sharp image size, a spin image size, and a zoom image size; loading a subset of said images; accepting user instructions selected from the group consisting of spin and zoom; and displaying on images pursuant to said user instructions while loading additional images not included in said subset of images.

### BACKGROUND

1. Field of the Art

This invention relates in general to methods for image processing and, more particularly, to providing a computer implemented system and method fix producing and displaying a “spinnable” or revolvable 360 degree images of products, people, or buildings, etc.

2. Description of the Prior Art

Online retailers regularly display images of devices using 360 degree image rotating software to examine all sides and views of the items. These product representations, use pre-processed, high-resolution photographs or images generated via simulation or editing by means of a variety of graphics software programs. See, for example, the following prior art references:

U.S. Pat. No. 5,003,444 discusses a structure for the all-around display of a flat image over an angle of 360°, wherein the image should be visible with a continuous luminous intensity, regardless of the rotary speed, and the maximum variation of the luminous flux from the light source—as a function of the rotary speed—must not reach a degree which is detectable by the human visual apparatus.

U.S. Pat. No. 6,061,468 discloses a method hi which the three-dimensional structure of an object is recovered from a closed-loop sequence of two-dimensional images taken by a camera undergoing some arbitrary motion. In one type of motion, the camera is held fixed, while the object completes a full 360° rotation about an arbitrary axis. Alternatively, the camera can make a complete rotation about the object. In the sequence of images, feature tracking points are selected using pair-wise image registration. Ellipses are fitted to the feature tracking points to estimate the tilt of the axis of rotation. A set of variables are set to fixed values while minimizing an image-based objective function to extract a set of first structure and motion parameters. Then the set of variables freed while minimizing of the objective function continues to extract a second set of structure and motion parameters that are substantially the same as the first set of structure and motion parameters.

U.S. Pat. No. 7,400,782 discloses a method for creating a 360 degree panoramic image from multiple images including the steps of (1) computing a gross rotation error ΔR between. first image and a calculated first image rotated to be stitched to a last image, a and (2) spreading the gross rotation error ΔR to each pixel on the panoramic image. Spreading the gross rotation error ΔR includes (1) computing a rotation angle θ0 and rotational axis n0 from the gross rotational error ΔR, (2) determining an angle α of each pixel, and (3) determining a compensation matrix Rc for each pixel using the following formula: Rc(α)=R(α/2πθ0). Spreading the gross rotation error ΔR further includes (4) tracing, a pixel on the panoramic image to a camel a optical center of images to form a first ray, (5) determining a second ray originating from the camera optical center that would be rotated by the compensation matrix Rc to coincide with the first ray, (6) the second ray to a second pixel on one of the images, and (7) painting the first pixel with color values of the second pixel.

U.S. Pat. No. 7,565,029 discloses a method of estimating three-dimensional camera position information from a series of two-dimensional images that form a panorama employs common features in adjoining image pairs in the series to estimate a transform between the images in the pairs. The common features are subsequently employed to adjust an estimated rotational component of each transform by reducing error between coordinates corresponding to the common features in three-dimensional space in image pairs, on a pair-by-pair basis. A global optimization of the position estimation, used for long sequences of images such as 360 degree panoramas, refines the estimates of the rotational and focal length components of the transforms by concurrently reducing error between all 3D common feature coordinates for all adjoining pairs.

U.S. Pat. No. 8,503,826 discloses a method of generating a 360 degree view model, wherein the method includes the following tasks: 1) provide a set of images (the number and size are unlimited), 2) reduce their features to the same brightness and contrast, 3) separate an object from a complex (heterogeneous) background in the images, 4) stabilize the objects in every image with respect to each other, and 5) process the resulting sequence of images to generate a 360 degree view.

U.S. patent application no. 20050180656 discloses a real-rime approximately 360 degree image correction system and a method for alleviating distortion and perception problems in images captured by omni-directional cameras. In general, the real-time panoramic image correction method generates a warp table from pixel coordinates of a panoramic image and applies the warp table to the panoramic image to create a corrected panoramic image. The corrections are performed using a parametric class of warping functions that include Spatially Varying Uniform (SVU) scaling functions. The SVU scaling functions and scaling factors are used to perform vertical scaling and horizontal sealing on the panoramic image pixel coordinates. A horizontal distortion correction is performed using the SVU scaling functions at at least two different scaling factors. This processing generates a warp table that can be applied to the panoramic image to yield the corrected panoramic image. In one embodiment the warp table is concatenated with a stitching table used to create the panoramic image.

Although the above described systems provide 360 degree images, the systems and methods of the prior art are limited in speed, image quality, image size, or the variety of platforms with which they can be used. Therefore, there is a need for systems and methods for automated computer-aided image processing for generation of a 360 degree view model.

### SUMMARY

The present system and method substantially obviate one or more of the above and other problems associated with conventional techniques for processing and presentation of 360 degree movable images.

The present invention generally comprises an Internet based computer-implemented method for generating and displaying an image of an object on a users computer screen, wherein said image may be rotated 360° about a horizontal axis and 360° about a vertical axis, the method comprising the steps of: accessing a database of digital images or a product; evaluating said user's computer hardware parameters, where said parameters are selected from the group consisting of Internet connection speed, Internet connection type, type of computing device, and type of Internet browser software; determining the dimensions of the display field of the computing device; determining a sharp image size, a spin image size, and a zoom image size; loading a subset of said images; accepting user instructions selected from the group consisting of spin and zoom; and displaying on images pursuant to said user instructions while loading additional images not included in said subset of images.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a functional block diagram of a prior art computer network for use with the present invention.

FIG. 2 shows a functional block diagram of an exemplary computing device for use with the present invention.

FIG. 3 shows an illustrative block diagram of an exemplary prior art mobile computing device.

FIG. 4 shows a software flow chart of an exemplary method according to the present invention.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

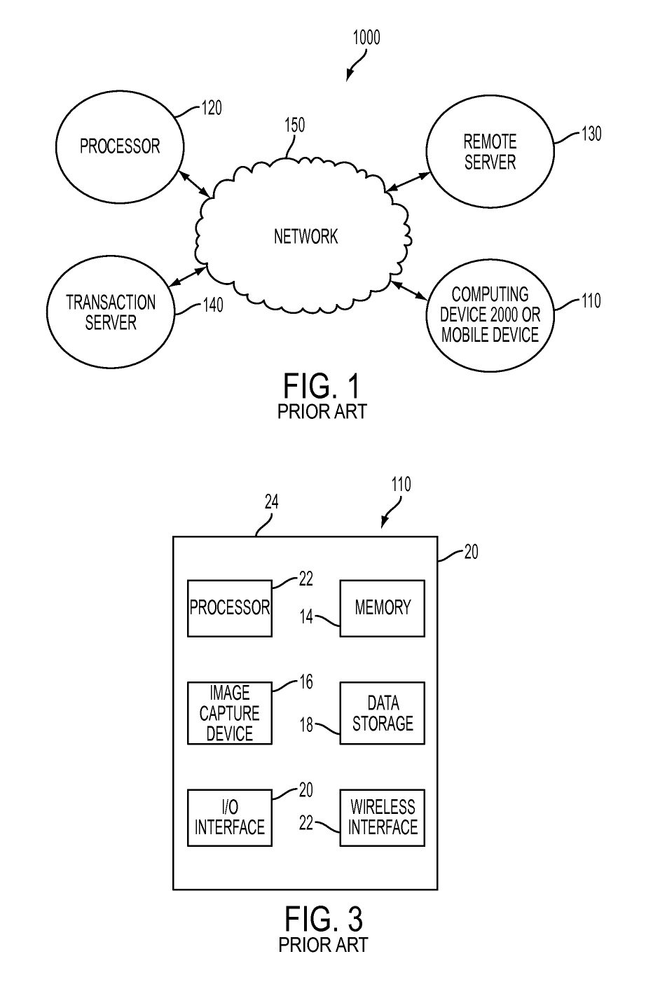

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Moreover, the terms “computer program medium” and “computer usable medium” are used to generally refer to physical storage media such as, RAM, ROM, a hard drive, or other memory storage device. These and other various forms of computer program media or computer usable media may store one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module to perform features or functions of the present invention as discussed herein.

As used herein, the term “module” may describe a given unit of functionality that can be performed. As used herein, a module may use any form of hardware, software, or a combination thereof. A module can include one or more processors, controllers, ASICs, PLAs, logical components, software routines or other mechanisms. Any module described herein may be used as discrete modules or the functions and features described can be shared in part or in total among one or more modules.

The present invention is a computer implemented method of providing a movable image of an object on a computing device screen, where the image is rotatable through 360 degrees about a horizontal axis and through 360 degrees about a vertical axis by cycling through a sequence of images. In the present method, the movable images ideally cover as much of the display as possible, have as much resolution as possible, and allow system users to zoom in and out of the image.

Turning first to FIG. 1, there is shown a functional block diagram of an exemplary computer communication system for use with the present invention. As shown in FIG. 1, system 1000 generally comprises: at least one computing device 2000, at least one computer processor 120, a remote server 130, and a transaction server 140, and a communication network 150, such as the Internet.

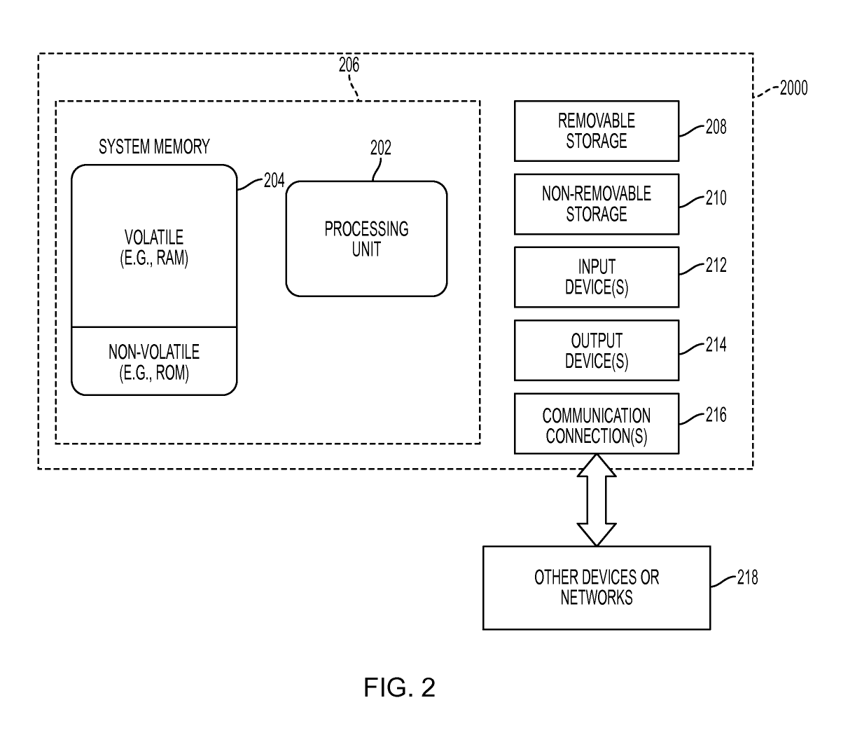

Referring next to FIG. 2, there is shown a functional block diagram generally illustrating a computing device 2000, one or more of which may be adapted for use in the illustrative system for implementing the invention. The computing device may be, for example, a personal computer, a handheld device such as a cell phone, tablet or a personal digital assistant, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

In its most basic configuration, computing device 2000 typically includes at least one processing unit 202 and system memory 204. Depending on the exact configuration and type of computing device, system memory 204 may be volatile (such as RAM), non-volatile (such as ROM, flash memory, etc.) or some combination of the two. The basic configuration of the device 2000 is illustrated in FIG. 2 within dashed line 206.

Device 2000 may also have additional features and functionality. For example, device 2000 may also include additional storage (removable and/or non-removable) including, but not limited to, magnetic or optical disks or tape. Such additional storage is illustrated in FIG. 1 by removable storage 208 and non-removable storage 210. Computer storage media includes volatile and nonvolatile, removable and non-removable media implemented in any method or technology for storage of information such as computer readable instructions, data structures, program modules, or other data. System memory 204, removable storage 208, and non-removable storage 210 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by device 2000. Any such computer storage media may be part of device 2000.

Device 2000 includes one or more input devices 212 such as a keyboard, mouse, pen, puck, voice input device, touch input device, scanner, or the like. One or more output devices 214 may also be included, such as a video display, audio speakers, a printer, or the like. Input and output devices are well known in the art and need not be discussed at length here.

Device 2000 also contains communications connection 216 that allows the device 2000 to communicate with other devices 218, such as over a local or wide area network. Communications connection 216 is one example of communication media. Communication media includes any information delivery media that serves as a vehicle through which computer readable instructions, data structures, program modules, or other data may be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g., radio frequency), infrared, and other wireless media. The term computer readable media as used herein includes both storage media and communication media.

Turning now to FIG. 3, there is shown an illustrative block diagram of an exemplary prior art mobile device 110, such as a smart phone, tablet computer, notebook computer, laptop computer, or the like for use with one or more aspects of the present invention. Mobile device 110 may be used in place of computing device 2000 in FIG. 1. As shown in FIG. 3, mobile device 110 generally comprises a processor 12, a memory storage device 14, an image capture device 16, a data storage device 18, a plurality of input/output interfaces 20, and a wireless communication interface 22, where all of these components are in electronic communication with one another and contained within a physical housing 24.

Mobile device 110 includes a mobile processor 12. Mobile processor 12 can be a microprocessor or the like that is configurable to execute program instructions stored in mobile memory 14 and/or the mobile data storage 18. Mobile memory 14 is a computer-readable memory that stores data and/or computer program instructions for execution by processor 12. Mobile memory 14 can include volatile memory, such as RAM and/or persistent memory, such as flash memory. Mobile data storage 18 is a computer readable storage medium that can be used to store data and or computer program instructions. Mobile data storage 18 includes a hard drive, flash memory, a SD card, and other types of data storage.

Mobile device 110 also includes image capture device 16, such as a digital camera. Image capture device 16 can include various features, such as auto-focus, optical zoom or digital zoom. Image capture device 16 captures image data and stores the data in mobile memory 14 and/or mobile data storage 18 of mobile device 110.

Mobile device 110 uses a wireless interface 22 to send and/or receive data across a wireless network. The wireless network can be a wireless LAN, a mobile phone carrier's network, Bluetooth, or other types of wireless network. I/O interface 20 allows mobile device 110 to exchange data with peripherals such as a personal computer system. A USB interface allows the connection of mobile device 110 to a USB port of a personal computer system to transfer data such as contact information to and from the mobile device and/or to transfer image data captured by image capture device 16 to the personal computer system.

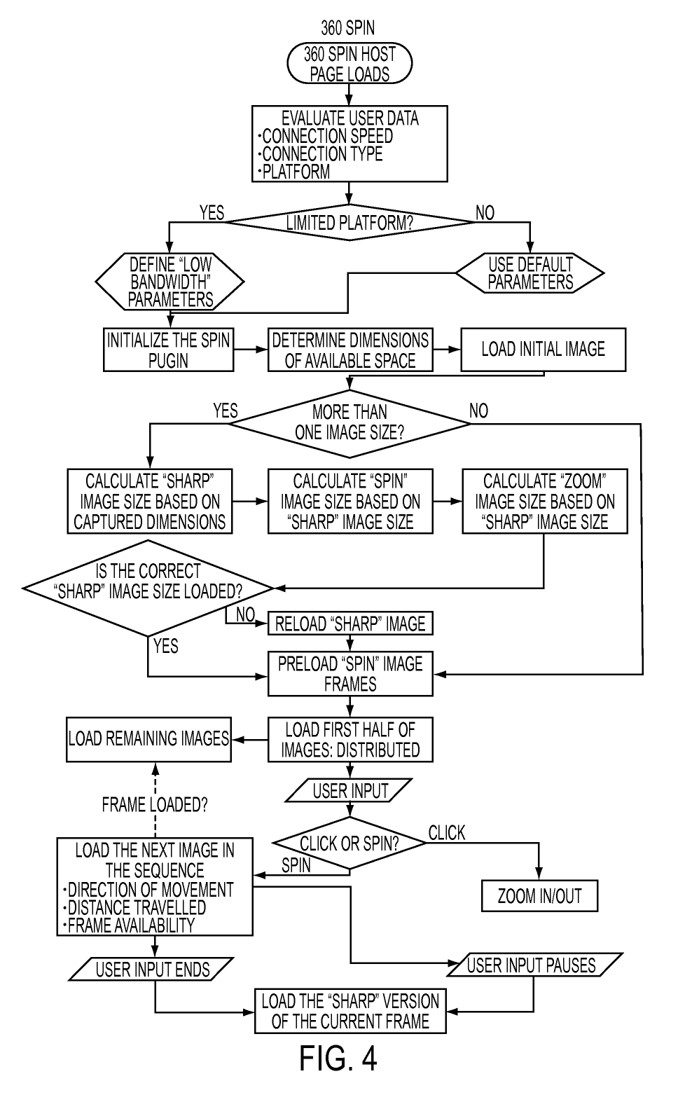

Referring now to FIG. 4, there is shown a software flow chart of an exemplary method according to the present invention. As described herein, the system of the present invention comprises a means to access a plurality of digital images of a product distributed along a horizontal axis and a plurality of digital images of product where said images are distributed along a vertical axis. Using the plurality of digital images of particular products, the present system and method produces three types of image outputs for users of the system and method; these outputs are: “spinning” images, “static” images, and “zoom” images. Image file size is the largest impediment to the speed of the present method. Thus, to make a user's experience as fast as possible, the different file sizes are used for different image output features of the present method.

As used herein, “spin” image is an up-sampled product image that is used for preloading the spin and displayed while spinning This is used to reduce wait time while loading the movable image and to reduce bandwidth. A “sharp” image is a full-sized image used for close user examination of a specific product and, a “zoom” image is a full resolution product image used for detailed examination of the product.

Referring still to FIG. 3, when the system of the present invention is accessed the default object of possible image sizes is created, which includes (in pixels) 200, 400, 600, 800, 1000, 1400, 1800, etc. The system includes a series of digital images of products or access to said plurality of images. The plugin also accepts a single image path, which skips many of the plugin's advanced calculations.

Various user data is considered in an attempt to tailor the experience to a specific user. Some of that data includes: Internet connection type, for example 4G wireless connections; Internet connection speed, for example 2000 Kbit/s; and computing device type, for example a smartphone. From this user information, the system of the present invention determines various spin parameters, such as the number of image frames to be used for the rotatable image and the size of the rotatable image.

Referring again to FIG. 3, once the present system is initiated, the dimensions of the viewing screen of the user's computing device are calculated by loading a sample image to determine the ratio of width to height. Specifically, this calculation comprises finding the bounding dimension (vertical or horizontal) of the image compared to the window, looping over the image sizes, comparing the image size to the bounding dimension, and selecting the first image that is a 1:1 or better ratio to the size of the viewing screen. In this manner, the viewing screen dimensions are used to determine which image size should be used for the “sharp” image.

Referring still generally to FIG. 3, the “sharp” image size is used to determine the “spin” image size using a sliding scale wherein the smaller end of the possible size spectrum uses a spin image that is 75% of the sharp image size, and the large end uses a spin image that is 55% of the sharp image.

Referring again to FIG. 3, the present system and method then determine an appropriate “zoom” image. The “zoom” image is calculated as 200% the size of the sharp image or the largest possible image size for the viewing screen of a user's computer device.

As further illustrated in FIG. 3, once the image sizes are calculated, the spin image is preloaded by loading no more than one-half of the total product images distributed around the x-axis and y-axis, and the “spin” image path. Once the first half of the images have been loaded, the second half of the images are loaded, and, in a parallel process, user interaction with the present system is allowed. When the user performs the spin interaction, each frame is loaded prior to displaying it, but if the frame has not been loaded, it is skipped to maintain the spun image display speed of the system.

When the user interaction stops, either by detecting a long pause or the user releasing the spin interaction in general, the “spin” image size is swapped for the “sharp” image size. To detect the “pause,” the velocity of movement can be calculated against a timer, thereby adjusting the pause detection. The “sharp” image can be preloaded by predicting the stopping point of the spin interaction based on a significant change is the spin velocity. When the user zooms-in on the image, the “sharp” image size is swapped for the “zoom” size.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. An Internet based computer-implemented method for generating and displaying an image of an object on a users computer screen, wherein said image may be rotated 360° about a horizontal axis and 360° about a vertical axis, the method comprising the steps of: accessing a database of digital images or a product; evaluating said user's computer hardware parameters, where said parameters are selected from the group consisting of Internet connection speed, Internet connection type, type of computing device, and type of Internet browser software; determining the dimensions of the display field of the computing device, determining a sharp image size, a spin image size, and a zoom image size; loading a subset of said images; accepting user instructions selected from the group consisting of spin and zoom; and displaying on images pursuant to said user instructions while loading additional images not included in said subset of images.
